(19) United States
(12) Patent Application Publication
(10) Pub. No.: US 2005/0089258 A1
(43) Pub. Date: Apr. 28, 2005

(54) Integrated optical isolator

(75) Inventors: Young-Il Kim, Gyeonggi-do (KR); Gwan-Su Lee, Seoul (KR); Seok Lee, Seoul (KR); Deok-Ha Woo, Seoul (KR); Sun-Ho Kim, Seoul (KR); Jae-Hun Kim, Seoul (KR); Young-Tae Byun, Gyeonggi-do (KR); Sung-Kyu Kim, Seoul (KR); Min-Chul Park, Seoul (KR); Seok-Ho Song, Seoul (KR)

Correspondence Address: HARNESS, DICKEY & PIERCE, P.L.C., P.O. BOX 828, BLOOMFIELD HILLS, MI, 48303, US

(73) Assignee: Korea Institute of Science and Technology, Seoul (KR)

(21) Appl. No.: 10/955,778

(22) Filed: Sep. 30, 2004

(30) Foreign Application Priority Data
Oct. 23, 2003 (KR) 10-2003-0074203

(51) Int. Cl. G02F 1/295; G02B 6/26; G02B 6/42

(52) U.S. Cl. 385/6; 385/4; 385/39; 385/40

(57) ABSTRACT

A semiconductor magneto-optical integrated optical isolator is realized with a Mach-Zehnder integrated optical isolator in which a cladding and a guiding layer of light waveguide are composed of magnetic material. Here, it uses nonreciprocal phase shift created when light propagation direction is changed. The fundamental element deriving this nonreciprocal phase shift is the Faraday rotation of magnetic material. Therefore, it is essential to have large Faraday rotation in order to fabricate a short length integrated optical isolator. However, since magnetic material of bulk state does not have large Faraday rotation, there need the length of several mm units for fabricating an isolator. The invention is to realize an integrated optical isolator using magneto-optical crystal in which magneto-optical material and dielectric substance have periodic structure. By the above reasons, magneto-optical crystal becomes to have bigger Faraday rotation than that of bulk state magnetic materials; thereby nonreciprocal phase shift becomes large and a short length integrated optical isolator can be fabricated. Thus, in order to reduce the device length of a Mach-Zehnder optical isolator, magneto-optical crystal having large Faraday rotation is used.

### BACKGROUND OF THE INVENTION

1. Field of the Invention

The invention relates to computer and optical communications, especially to an integrated optical isolator which uses magnetic photonic crystal in which magneto-optical material and dielectric substance have periodic structures. Here, the magnetic photonic crystal has large Faraday rotation, thus increases phase shift.

2. Description of the Related Art

With rapid advances in recent optical communication systems, a high level monolithical integration for diverse optical components is required and there have been a lot of trials for it. For optical integration and stable operation of optical components, the demands for isolator to prevent needless reflection occurred in the course of light propagation have been increased. Since the devices of current commercial optical isolators are bulk components, the isolators can not be used as integrated forms.

Therefore, it is said that an integrated optical isolator is an essential component for its high level integration. Recently, new alternatives for an isolator using nonreciprocal effect that optical characteristics are altered according to the direction of light propagation have been suggested, and the realization techniques on them have been actively studied.

There have been studies on an optical integrated isolator using magneto-optical material, and the methods that magneto-optical material is used for a guiding layer (J. Fujita et al., Appl. Phys. Lett., 76, 2158 (2000)) and a cladding layer (H. Yokoi, et al., Appl. Opt., 39, 6158 (2000)) in light waveguide have been presented.

For the case that magneto-optical material is used for a guiding layer, since most of lights penetrate to magneto-optical material, the device length of isolator can be reduced, but there is a disadvantage that it is difficult to achieve monolithical integration. On the contrary, for the case that optical material is used for a cladding layer, monolithical integration can be achieved, but there is a disadvantage that the device length becomes long due to small nonreciprocal phase shift.

### SUMMARY OF THE INVENTION

The objective of the invention is to provide an integrated optical isolator which uses magnetic photonic crystal in which magneto-optical material and dielectric substance have periodic structures. Here, magnetic photonic crystal has large Faraday rotation, and thus increases phase shift.

Using the property of magnetic photonic crystal that Faraday rotation is larger than that of bulk magnetic material, the present invention is to realize a shorter length integrated optical isolator than the existing Mach-Zehnder integrated optical isolators.

### BRIEF DESCRIPTION OF THE DRAWINGS

FIG. 1 is a schematic diagram illustrating magnetic photonic crystal structure in accordance with an embodiment of the present invention.

FIG. 2 is a graphical illustration showing transmittance and Faraday rotation of magneto-optical crystal and magnetic photonic crystal respectively in accordance with the present invention.

FIG. 3 is a conceptual view illustrating operational mechanism of Mach-Zehnder integrated optical isolator using magnetic photonic crystal as a cladding layer in accordance with the present invention.

FIG. 4 is a cross-sectional view illustrating Mach-Zenhder integrated optical isolator in accordance with the present invention.

FIG. 5 is a graphical view illustrating the calculation results of nonreciprocal phase shift for integrated optical isolator in the case that magnetic photonic crystal is used for a cladding layer in accordance with the present invention.

### DESCRIPTION OF THE NUMERALS ON THE MAIN PARTS OF THE DRAWINGS

1: a magnetic photonic crystal
11: a magneto-optic material
12: a dielectric substance
2: a substrate
3: a guiding layer
4: an insulation layer
5: an electrode

### DETAILED DESCRIPTION OF THE EMBODIMENTS

An optical isolator using Mach-Zehnder can be realized by nonreciprocal phase shift in between forward and backward directions of light propagation—which is the characteristic of magneto-optical material in a cladding layer. The fundamental element that derives nonreciprocal phase shift for magneto-optical material is Faraday rotation of the material.

However, in the wavelength-band of optical communications, Faraday rotation of magneto-optical material having high light permeability is not large.

Thus, using magneto-optical material in bulk state or thin film form, the length needed to isolate light becomes long. In order to shorten the length of optical integrated isolator device, Faraday rotation of magneto-optical material should be large. For the method to enlarge Faraday rotation by using the same magneto-optical material, the magnetic photonic crystal method that periodically piles up magneto-optical material and generic dielectric substance has been studied. Magnetic photonic crystal is the crystal that magneto-optical material and dielectric substance have periodic structure. If two materials which have different dielectric constants have periodic structure, band gap that lights can not be propagated is created within the material. Then if a specific intentional defect is made in this structure, a mode that the defect allows some specific lights except for most of lights to be propagated is formed. Since the group velocity of the mode created by the above method is very slow, the effective length sensing light becomes large. Thus, even if the total length of magneto-optical material is short, there is the effect that the effective length sensing light is large; thereby, Faraday rotation is to be increased. Using the property of magnetic photonic crystal that Faraday rotation is larger than that of bulk magnetic material, the present invention is to realize a shorter length integrated optical isolator than the existing Mach-Zehnder integrated optical isolators.

For increasing phase shift through the increment of Faraday rotation, the embodiment of the present invention provides an integrated optical isolator comprising; a magnetic photonic crystal which magnetic photonic material and dielectric substance are periodically arranged for light propagation direction; and a magnetization mean that magnetizes the said magnetic photonic crystal.

At the moment, the said magnetic photonic crystal can be a cladding layer or a guiding layer of the light waveguide.

Moreover, the said magnetization mean uses an electrode, and the said electrode is in parallel with two light waveguides and designed to generate opposite directional magnetic fields, where light propagation and current directions are same in the one side of light waveguide and opposite in the other side.

Additionally, for increasing transmittance and Faraday rotation of the said magnetic photonic crystal, it is desirable that magneto-optical material and dielectric substance having different dielectric constant are arranged adjacently.

On the other hand, the said dielectric substance can be a multilayer thin film composite having the same or different dielectric constant.

Hereinafter, referring to appended drawings, the structures and operational principles of the present invention are described in detail.

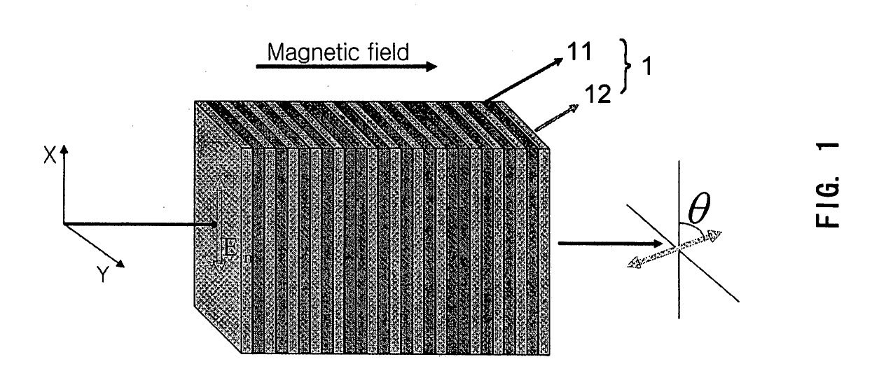

FIG. 1 is a view illustrating the structure of magnetic photonic crystal formed periodically with magneto-optical material and dielectric substance. As illustrated in FIG. 1, magnetic photonic crystal (1) is repeatedly and periodically formed with magneto-optical material (11) and general dielectric substance (12) in the vertical direction to the magnetic field. Under these situations, the light directed toward magnetic field becomes to have large Faraday rotation after it passes through the magnetic photonic crystal (1). Moreover, to increase the transmittance and Faraday rotation of the above magnetic photonic crystal, magneto-optical material and dielectric substance which have different dielectric constants respectively are arranged adjacently. Here, the above dielectric substance can be a composite material of multilayer thin film having the same or different dielectric constant.

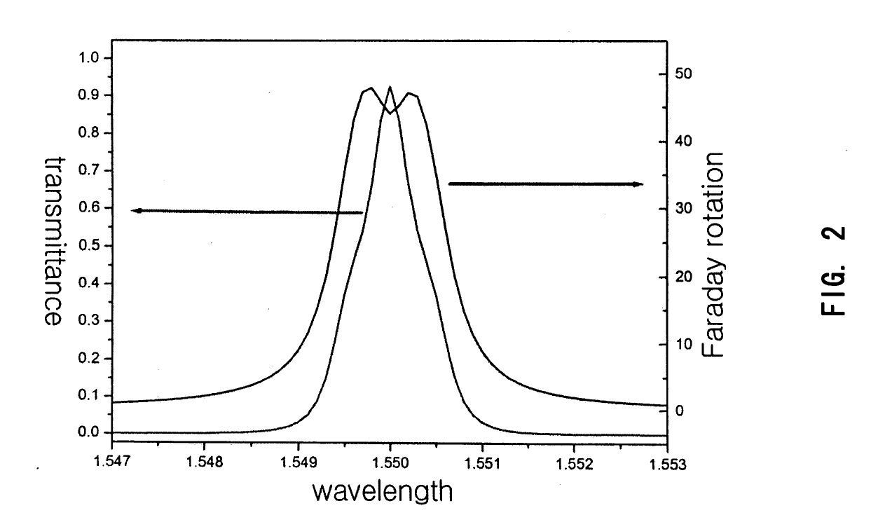

FIG. 2 is an example of the transmittance and Faraday rotation for the transmitted light to magnetic photonic crystal. The material, magnetic photonic crystal (1), has larger Faraday rotation than the existing bulk magneto-optical material (11), and the fact is a fundamental element to exhibit nonreciprocal phase shift. Therefore, since nonreciprocal phase shift is larger in the case of using magnetic photonic crystal (1) than using bulk material, the length of device can be reduced.

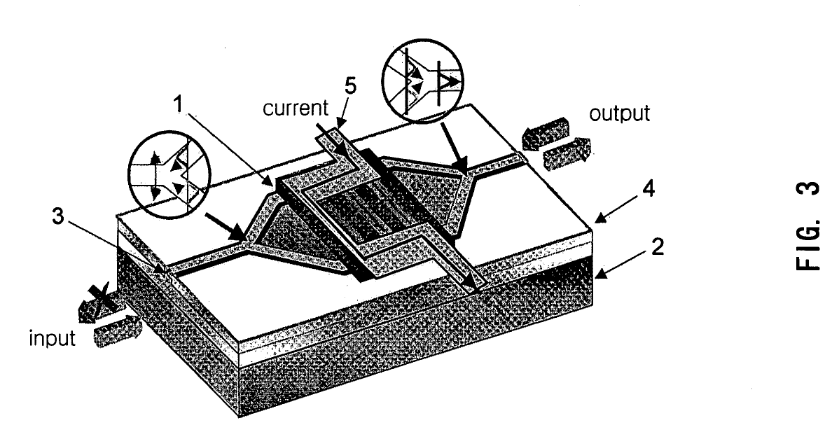

FIG. 3 is a conceptual view illustrating operational mechanism of Mach-Zehnder integrated optical isolator using magnetic photonic crystal as a cladding layer and phase shift of magnetic photonic crystal.

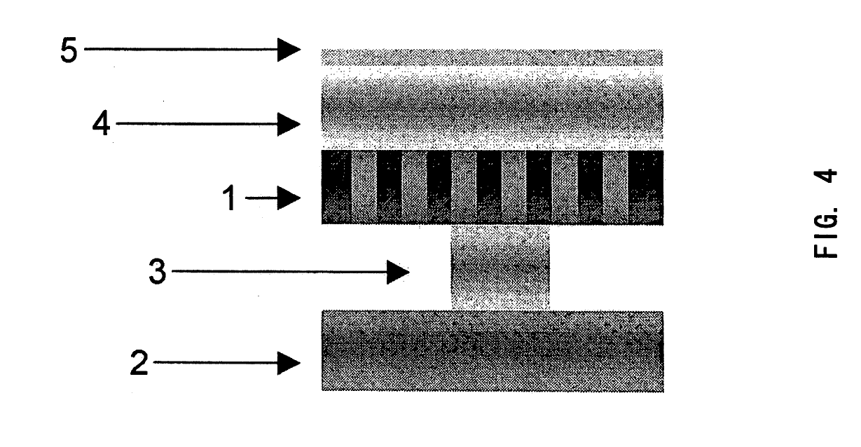

FIG. 4 is a cross-sectional view illustrating Mach-Zenhder integrated optical isolator.

As shown in FIG. 4, a substrate (2), a guiding layer (3), a magnetic photonic crystal (1), an insulation layer (4) and an electrode (5) are piled up in regular sequence. A guiding layer (3) is formed on a substrate (2), then the magnetic photonic crystal (1) which makes nonreciprocal phase shift for the light progressing toward magnetic field is formed on the said guiding layer (3), and the electrode (5) which magnetizes the above magnetic photonic crystal is built on the magnetic photonic crystal (1). Meanwhile an insulation layer (4) is created in between the above magnetic photonic crystal (1) and the electrode (5).

Through direct wafer bonding method, magnetic photonic crystal (1) is used as cladding layer in the Mach-Zenhder light waveguide. Magnetic photonic crystal (1) on the light waveguide is in the vertical direction to light propagation direction. In order to generate opposite directional magnetic field in parallel with the light waveguide, an electrode (5) is designed as shown in FIG. 3. As an electrode is charged with electric current, then magnetic photonic crystal (1) is magnetized. The light passing through the light waveguide becomes to have nonreciprocal phase shift.

At this point, as fabricating so that the path difference in two arms of Mach-Zehnder light waveguide becomes 90°, reciprocal phase shift of Mach-Zehnder light waveguide is made to be 90°. If the length of nonreciprocal phase shifter is made to be 90°, forward propagating light makes nonreciprocal phase shift be—90° and reciprocal phase shift be 90°, thereby the phases are the same and the forward propagating light can be propagated. Otherwise backward propagating light can be cancelled because 90° nonreciprocal phase shift and 90° reciprocal phase shift have 180° phase difference.

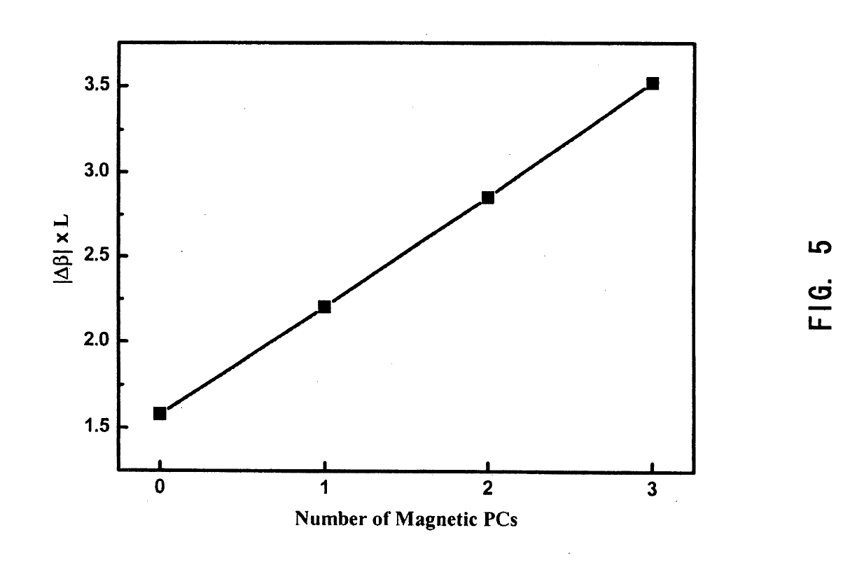

As an example of using magnetic photonic crystal as a cladding layer of the light waveguide, FIG. 5 is a graphical view illustrating nonreciprocal phase shift according to the number of photonic crystal. As shown in FIG. 5, under the same length of light waveguide, the phase shift for the case that light waveguide has magnetic photonic crystal (1) is over two times bigger than that for the case that light waveguide does not have magnetic photonic crystal (1). Therefore, if an optical isolator is realized using magnetic photonic crystal (1), it is possible no only to achieve monolithical integration but to reduce the length of device.

As such, rapid progress in the field of optical communication systems is requiring high level monolithical integration of diverse optical components, and for the purpose of this optical integration various optical signal processing components are used. These components should be stabilized, and thus the isolators to protect needless light reflections occurred in the course of light propagation are essentially required.

As described in the above, the integrated optical isolator in accordance with the present invention can reduce the device length shorter than Mach-Zehnder integrated optical isolator by virtue of large Faraday rotation of magnetic photonic crystal. Thus, the present invention has an appropriate structure for optical integration. Moreover, as making the integration of a complete optical infrastructure possible, the present invention will be an influential technology for optical information processing systems. Being able to be highly reliable and to minimize optical path loss, the invention can be appropriately applied to fiber-optic amplifier, WDM systems, fiber-optic laser and sensor, and optical measurement equipments.

Since those having ordinary knowledge and skill in the art of the present invention will recognize additional modifications and applications within the scope thereof, the present invention is not limited to the embodiments and drawings described above.

1. An integrated optical isolator for increasing phase shift through the increment of Faraday rotation, comprising;
a magnetic photonic crystal arranged periodically magnetic photonic material and dielectric substance for light propagation direction; and
a magnetization mean that magnetizes the said magnetic photonic crystal.

2. In claim 1, the integrated optical isolator is that the said magnetic photonic crystal is a cladding layer of light waveguide.

3. In claim 1, the integrated optical isolator is that the said magnetic photonic crystal is a guiding layer of light waveguide.

4. In claim 1, the integrated optical isolator is that the said magnetization mean is an electrode.

5. In claim 4, the integrated optical isolator is that the said electrode is formed to generate opposite directional magnetic field in parallel with two waveguides, in one side of waveguide, light propagation direction is the same as current direction, in the other waveguide, light propagation direction is opposite to current direction.

6. In claim 1, the integrated isolator is that, for increasing transmittance and Faraday rotation of the said magnetic photonic crystal, one of magneto-optical material and dielectric substance having different dielectric constants is arranged adjacently.

7. In claim 6, the integrated optical isolator is that the said dielectric substance is a multilayer thin film composite material having the same or different dielectric constant.

8. In claim 2, the integrated isolator is that, for increasing transmittance and Faraday rotation of the said magnetic photonic crystal, one of magneto-optical material and dielectric substance having different dielectric constants is arranged adjacently.

9. In claim 3, the integrated isolator is that, for increasing transmittance and Faraday rotation of the said magnetic photonic crystal, one of magneto-optical material and dielectric substance having different dielectric constants is arranged adjacently.

10. In claim 4, the integrated isolator is that, for increasing transmittance and Faraday rotation of the said magnetic photonic crystal, one of magneto-optical material and dielectric substance having different dielectric constants is arranged adjacently.

11. In claim 5, the integrated isolator is that, for increasing transmittance and Faraday rotation of the said magnetic photonic crystal, one of magneto-optical material and dielectric substance having different dielectric constants is arranged adjacently.

12. In claim 8, the integrated optical isolator is that the said dielectric substance is a multilayer thin film composite material having the same or different dielectric constant.

13. In claim 9, the integrated optical isolator is that the said dielectric substance is a multilayer thin film composite material having the same or different dielectric constant.

14. In claim 10, the integrated optical isolator is that the said dielectric substance is a multilayer thin film composite material having the same or different dielectric constant.

15. In claim 11, the integrated optical isolator is that the said dielectric substance is a multilayer thin film composite material having the same or different dielectric constant.
